(19) United States
(12) Patent Application Publication
(10) Pub. No.: US 2008/0184867 A1
(43) Pub. Date: Aug. 7, 2008

(54) DRUMSTICK WITH MULTIPLE TUBE STRUCTURE

(76) Inventors: Stephen J. Davis, Newtown, PA (US); Roberto Gazzara, Mestre (IT); Mauro Pinaffo, Camposampiero (IT); Mauro Pezzato, Treviso (IT); Michele Pozzobon, Fossalunga di Vedelago (IT)

Correspondence Address: FOX ROTHSCHILD, LLP, 625 LIBERTY AVENUE, PITTSBURGH, PA, 15222-3155, US

(21) Appl. No.: 12/022,613

(22) Filed: Jan. 30, 2008

Related U.S. Application Data
(60) Provisional application No. 60/899,164, filed on Feb. 1, 2007.

(51) Int. Cl. G10D 13/02

(52) U.S. Cl. 84/422.4

(57) ABSTRACT

A drumstick is formed of multiple composite tubes bonded to one another along a common wall, wherein apertures are molded between the tubes to improve the stiffness, strength, resiliency, aerodynamics and comfort of the drumstick.

### RELATED APPLICATIONS

This application claims the benefit of U.S. Provisional Application Ser. No. 60/899,164, filed Feb. 1, 2007, entitled “Drumstick Having a Multiple Tube Structure.”

### FIELD OF THE INVENTION

The present invention relates to a structure formed by curing multiple tubes of an uncured composite material in a mold to form a structure having internal reinforcing walls, and, in particular, a drumstick made in this manner.

### BACKGROUND OF THE INVENTION

The performance of a drumstick is determined by a number of factors, such as weight, bending flex, resiliency, vibration damping, and strength. The traditional drumstick is a solid wood structure with a constant circular cross section and a tapered region to which a protective tip is attached. The shape can vary according to the application and performance desired.

The weight and balance of a drumstick is a critical feature in determining performance. The drumstick must be maneuverable for quick playing action, yet have sufficient weight to strike a percussion instrument, typically a drum or cymbal, with authority. For traditional wooden drumsticks, weight reduction is only possible by reducing the diameter and/or length of the drumstick.

The center of gravity of the drumstick is also important because it affects how the drumstick bounces off of the percussion instrument. It addition, the drumstick must feel balanced in the hand and stay balanced when used with various playing styles.

The stiffness and resiliency of the drumstick are also important. The stiffness can affect the sound generated when the drumstick strikes a percussion instrument. The resiliency is important because it determines how the drumstick rebounds off of the percussion instrument. A high resiliency is good for a quick rebound for fast paced playing styles. A low resiliency is good for tones with a strong attack and prolonged sustain.

Vibration damping is another critical performance factor. Vibration damping can affect the sound generated as well as the comfort of the musician. The drumsticks can impact numerous objects, including surfaces other than the playing surfaces of the percussion instruments, many times during a playing session, imparting shock and vibration to the hands of the musician.

There are numerous examples of prior art using injection molding as an alternative to the traditional wood drumsticks. U.S. Pat. No. 3,958,485 (Peters) describes a hollow tubular injection molded structure with internal reinforcing ribs; U.S. Pat. No. 4,047,460 (Fielder, et. al) describes a hollow drumstick formed from two parts which are fused together to form an integral drumstick; U.S. Pat. No. 4,763,557 (Donohue) describes a hollow injection molded drumstick; U.S. Pat. No. 4,768,943 (Honsa) describes a method to produce a hollow injection molded drumstick; U.S. Pat. No. 5,341,716 (Donohue) describes a drumstick with an injection molded tubular sleeve over an internal body; U.S. Pat. No. 6,673,994 (Broome et. al) describes a foamed thermoplastic drumstick; and U.S. Pat. No. 6,960,712 (Citron et. al) describes an injection molded drumstick comprised of internal insert of a different stiffness. In general, injection molding uses thermoplastic resins that can optionally be reinforced with short fibers in a random orientation.

Another alternative is to use long fiber-reinforced polymer composites to form the drumstick. Longer fiber-reinforced composites are stronger than composites composed of thermoplastic with short fibers, which is typically used in injection molding. The long fiber-reinforced composites can be oriented to achieve specific performance characteristics. Examples are U.S. Pat. No. 4,040,323 (Kline) which describes a solid drumstick formed from continuous fiber reinforced polyester resin; U.S. Pat. No. 4,300,438 (Handal) describes a solid drumstick formed from woven cotton fibers impregnated with a phenolic resin; U.S. Pat. No. 4,320,688 (Donohue) describes a drumstick with an outer polymer shell over a long fiber reinforced internal core;’ U.S. Pat. No. 4,385,544 (Heiskell) describes a hollow composite drumstick formed of long fiber reinforced polymer; and U.S. Pat. No. 5,602,355 (Lipp) describes a solid drumstick formed of a long fiber reinforced composite.

The single, hollow drumstick has been the traditional way to design and manufacture composite drumsticks. It also makes sense from an efficiency viewpoint, that the single hollow tube maximizes inertial properties, since the material is displaced away from the central axis of the tube. This has been the traditional composite drumstick structure.

When a single hollow tube has a sufficient wall thickness, for example when weight is not critical, the design can sufficiently provide adequate stiffness and strength. However, as mentioned previously, when the wall thickness becomes thin relative to the diameter of the tube, the tubular part is susceptible to buckling under the compressive forces which are always present in drumstick.

While the drumsticks in the identified prior art all have various advantages, there exists a continuing need for an improved drumstick that has the combined features of light weight, improved bending stiffness, improved strength, improved aerodynamics and improved comfort.

### SUMMARY OF THE INVENTION

The present invention comprises a drumstick constructed with multiple tubes, wherein a portion of the tubes are fused together along much of their lengths to form internal reinforcing walls. The portion of the tubes not fused with other tubes forms the outer surface of the drumstick. In the preferred embodiment of the invention, two tubes are used, forming a single internal reinforcing wall, although, in theory, any number of such tubes could be used. The tubes preferably are separated from one another at selected locations to form apertures that act as double opposing arches, providing improved means of adjusting stiffness, resiliency, strength, comfort, and aerodynamics.

The internal reinforcing wall adds significantly to improving the structural properties of the drumstick. The internal wall helps resist bending deflections and hard impacts, resulting from striking the metal rim of a drum or other hard percussion instrument. In addition, during bending or impact, the shape of the drumstick is much more easily maintained, eliminating the tendency to buckle the cross section, which would lead to a catastrophic failure of the drumstick.

The present invention is designed to provide a combination of light weight, tailored stiffness, improved strength, improved comfort, improved aerodynamics, and improved aesthetics over the current prior art.

The present invention provides a new and improved drumstick of durable and reliable construction which may be easily and efficiently manufactured at low cost with regard to both materials and labor. The improved drumstick can provide specific stiffness zones at various orientations and locations along the length of the stick, superior strength and fatigue resistance, improved shock absorption and vibration damping characteristics and improved impact resistance. In addition, the improved drumstick exhibits improved aerodynamics and has a unique look and improved aesthetics.

For a better understanding of the invention and its advantages, reference should be made to the accompanying drawings and detailed description in which various embodiments of the invention and their method of manufacture are illustrated.

### BRIEF DESCRIPTION OF THE DRAWINGS

FIG. 1 is a side view of a drumstick constructed in accordance with an embodiment of the present invention.

FIG. 1A is a cross sectional view of the drumstick taken along lines 1A-1A of FIG. 1.

FIG. 1B is a cross sectional view of the drumstick taken along lines 1B-1B of FIG. 1.

FIG. 1C is an isometric cut away view of a portion of the drumstick shown in FIG. 1.

FIG. 2 is a longitudinal sectional view of a portion of the drumstick.

FIG. 3 is an isometric view of a drumstick constructed with a multiple tube design.

FIG. 3A is a cross section of the drumstick in FIG. 3 taken along lines 3A-3A.

FIG. 3B is a cross section of the drumstick in FIG. 3 taken along lines 3B-3B.

FIG. 3C is an isometric cutaway view of a portion of the drumstick shown in FIG. 3.

FIG. 4 shows an alternative example of how multiple ports could be oriented in a multiple tube construction

FIG. 4A is a cross sectional view along the lines 4A-4A of FIG. 4.

FIGS. 5A-5D show various shapes of ports.

FIGS. 6-7 are perspective views illustrating a process for forming a frame member to a single tube portion.

FIG. 8 shows a cut away view of the taper portion of the drumstick showing attachment of the tip.

FIG. 9 is a longitudinal sectional view of an example of a drumstick structure prior to molding.

FIG. 10 is a cross sectional view of the drumstick with a protective impact layer.

The same reference numerals refer to the same parts throughout the various figures.

### DETAILED DESCRIPTION OF THE INVENTION

In one aspect of the invention, as described below, the drumstick is formed of two or more tubes which are fused together to form a common internal wall (or walls, in the case of more than two tubes). These common internal walls improve the strength of the drumstick by acting as a brace to resist bending and impact loads. This added strength allows the drumstick to resist compressive buckling loads such as those found near the tip at the taper region

In another aspect of the invention, at selected locations, the facing, fused surfaces of the tubes are kept apart during molding to form openings. On either side of the openings, the tubes are fused together. The openings so formed are referred to herein as “ports” and appear as holes through the drumstick These ports are formed without drilling or otherwise severing any reinforcement fibers.

The resulting structure is found to have superior performance characteristics for several reasons. The ports are preferably in the shape of double opposing arches allowing the structure to deflect, which deforms the ports, and return with more resiliency. Thus, in the preferred embodiment, the ports are circular or elliptical in shape, however, in alternate embodiments, the ports may be of any shape. The ports allow greater bending flexibility in the drumstick than would traditionally be achieved in a single tube design. The structure also provides improved comfort by absorbing shock and damping vibrations, due to the deformation of the ports. Finally, the ports allow air to pass through, which improves the maneuverability of the drumstick.

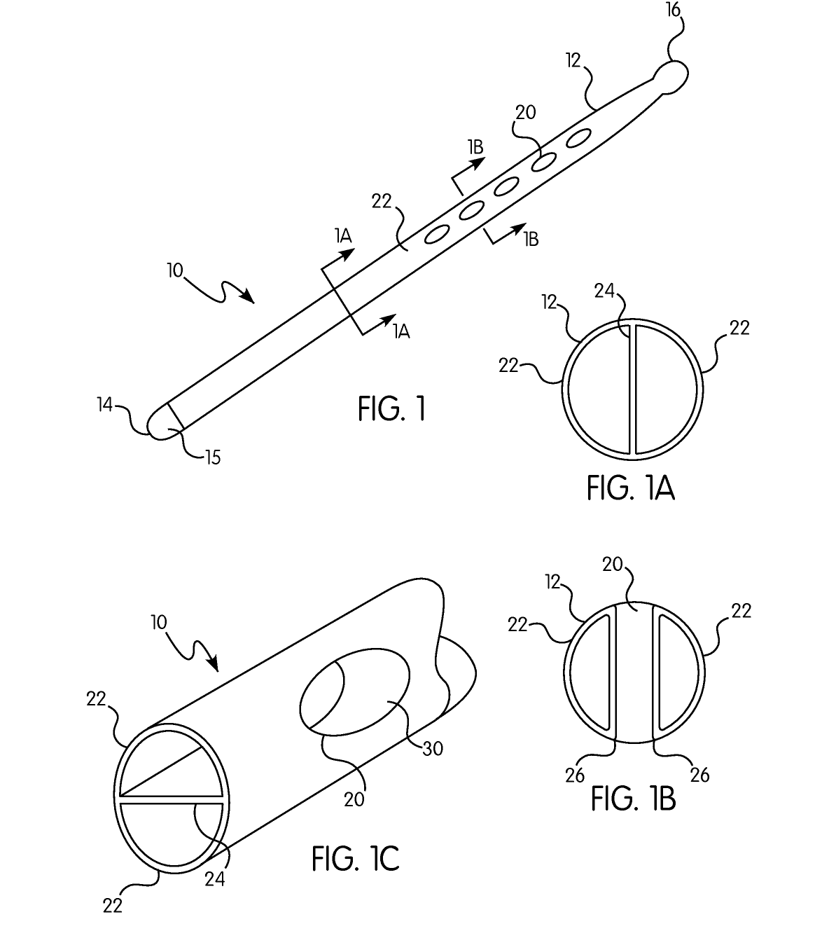

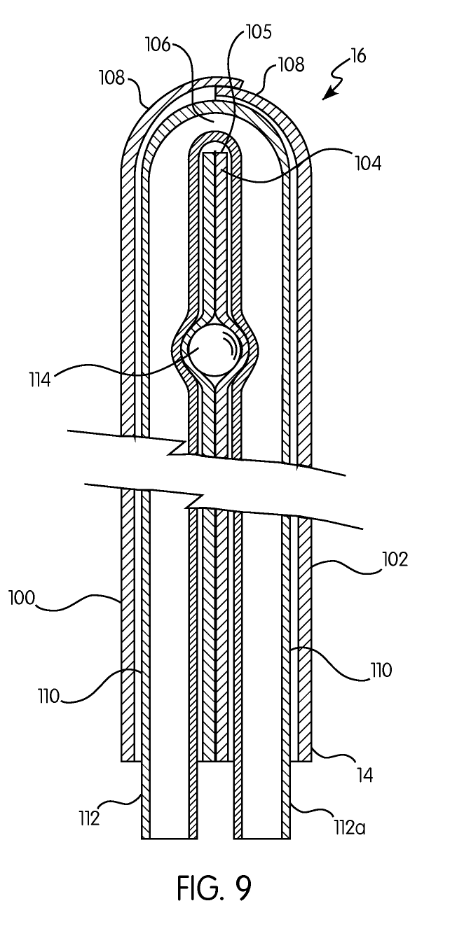

FIG. 1 illustrates a drumstick, which is referred to generally by the reference numeral 10. Drumstick 10 includes a tapered portion 12 where the diameter of the shaft decreases between the butt end 14 and the tip end 16. In this example, tip end 14 is closed by a butt cap 15, which is attached to the non-tapered end of the drumstick shaft after molding, by an adhesive or other suitable means. A suitable molding process is described in connection with FIG. 9.

FIG. 1 shows one preferred embodiment wherein drumstick 10 defines one or more ports 20, oriented with their axes perpendicular to the longitudinal axis of the drumstick. Ports 20 may be located along the length of drumstick 10, including at tapered portion 12.

FIG. 1A, taken along line 1A-1A of FIG. 1, shows the two hollow tubes 22 which form the structure of the shaft in this embodiment. Hollow tubes 22 are fused together to form internal wall 24. Preferably, the location of internal wall 24 is such that the longitudinal axis of the drumstick is contained within the plane of the wall. Both of hollow tubes 22 should be about the same size and, in this embodiment, when molded, form a “D” shape.

FIG. 1B, taken along line 1B-1B of FIG. 1, shows that, at the locations of ports 20, hollow tubes 22 are separated from one another to form the walls defining ports 20. It is preferred that the outer edges 26 of ports 20, at their intersection with the external surface of drumstick 10, be radiused (i.e., rounded) so as to reduce the stress concentration and to facilitate the molding process.

FIG. 1C is an isometric view of drumstick 10 isolated to one port, which shows two hollow tubes 22 and internal wall 24. Also shown is port 20 formed by curved wall 30, which may have a generally cylindrical shape. In this particular example, the axis of port 20 is oriented 90 degrees to the longitudinal axis of drumstick 10.

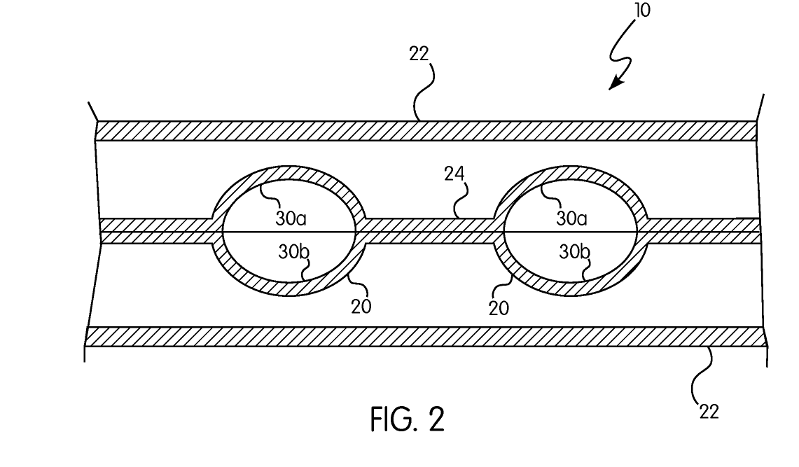

FIG. 2 is a section taken through the longitudinal axis of drumstick 10 which shows that, at locations other than at the ports, hollow tubes 22 are positioned side-by-side and are fused together along their lengths to form common internal wall 24 that extends across the diameter of drumstick 10, preferably bisecting the shaft interior. At selected locations, e.g., where ports 20 are to be formed, the facing surfaces of tubes 22 are separated during molding to form ports 20 in the shape of double opposing arches 30a and 30b, which act as geometric supports to allow deformation and return. In addition, internal wall 24 provides structural reinforcement to resist deformations and buckling failures.

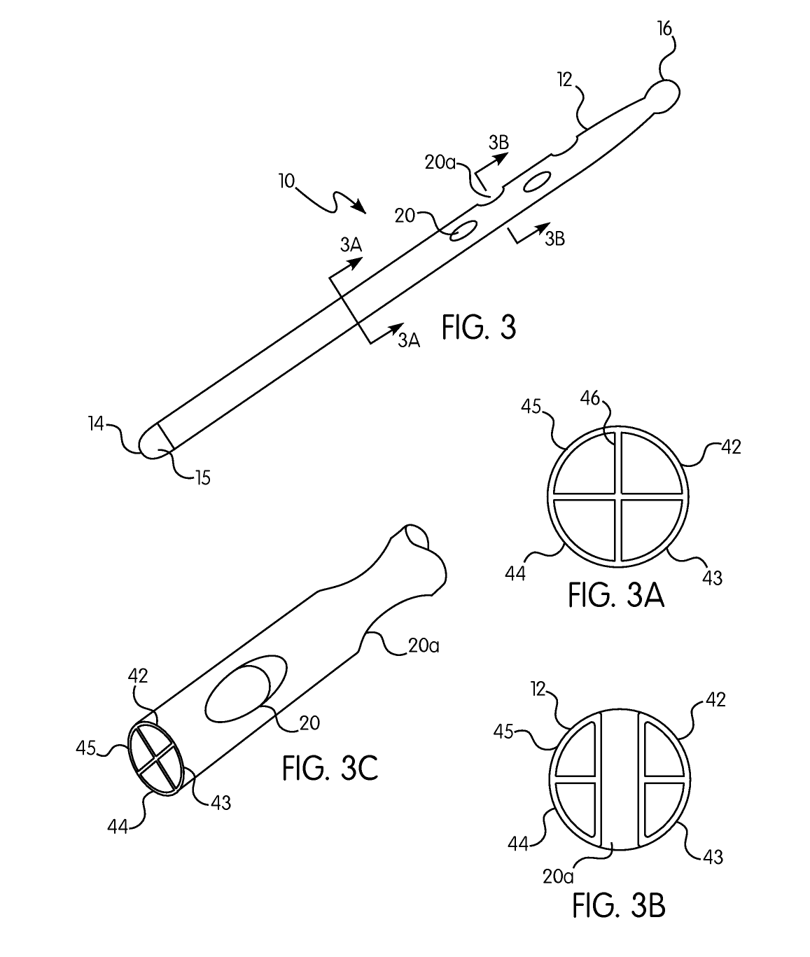

FIG. 3 shows an alternative embodiment of the drumstick in which a multiple tube construction is used, which allows for ports 20 and ports 20a to be oriented at different angles.

In this particular example, the axes of ports 20 and 20a are oriented at 90 degrees with respect to each other, but other offset angles may also be achieved. A drumstick with this type of design would be considered to have the benefits of having the ports oriented in two directions. This particular example shows the ports 20 and 20a alternating. It is also possible to arrange the ports in any desirable sequence, orientation and location.

To form ports in multiple directions, multiple tubes are needed. In the example of FIG. 3A, 4 tubes, 42, 43, 44, and 45, are used in the molding process, which creates an internal wall 46 in the form of an “X”, as shown.

FIG. 3B shows a cross section in the region of one of ports 20a. At the location of port 20a, hollow tubes 42 and 43 are fused together, and hollow tubes 44 and 45 are fused together, but tubes 42 and 43 remain separated from tubes 45 and 44 respectively during molding to create port 20a. A cross section taken through one of ports 20 (not shown), would show tubes 42 and 45 being fused together and tubes 43 and 44 being fused together, but with tubes 42 and 45 remaining separated from tubes 43 and 44 respectively to form a port offset 90 degrees from the port shown in FIG. 3B.

FIG. 3C is an isometric view of a cutaway portion of drumstick 10 of FIG. 3 showing ports 20a with axes offset 90 degrees from the axes of ports 20.

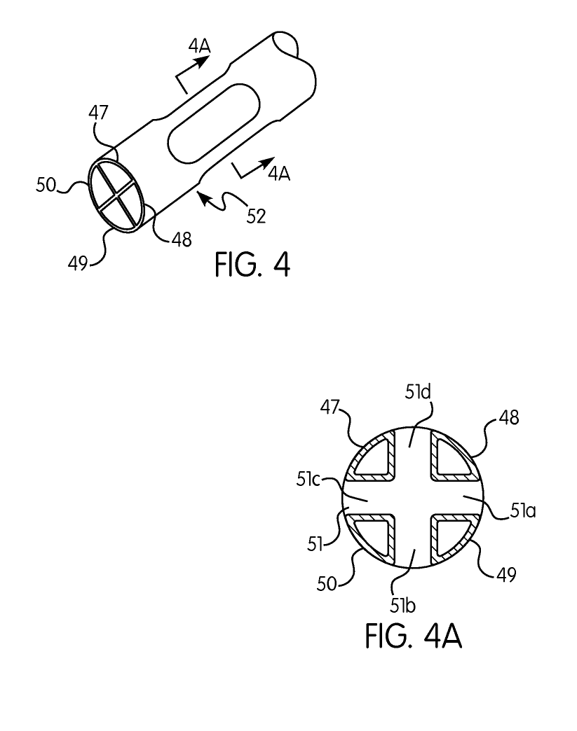

FIG. 4 is an isometric cutaway view of a four tube structure 52 with ports 20 and 20a being co-located along the shaft of drumstick 10. In this example, hollow tubes 47, 48, 49, and 50 are all separated in the same location to form port 51 therebetween.

FIG. 4A is a cross sectional view of the tube structure 52 of FIG. 4 taken along line 4A-4A. Here it can be seen that, because all four hollow tubes are separated, there results an open port 51 that has four openings 51a-d. This particular embodiment would provide more flexibility and resiliency for both directions at the same location.

In a multiple tube design, there can be any number of ports and orientations of ports depending on the number of hollow tubes used and how many are separated to form these ports. In addition, it is possible to create a “Y” shaped port having three openings, using three tubes, wherein the center of the “Y” shape intersects the longitudinal axis of drumstick 10. In such a design, the internal wall formed from the fusing of the three tubes would also be “Y” shaped.

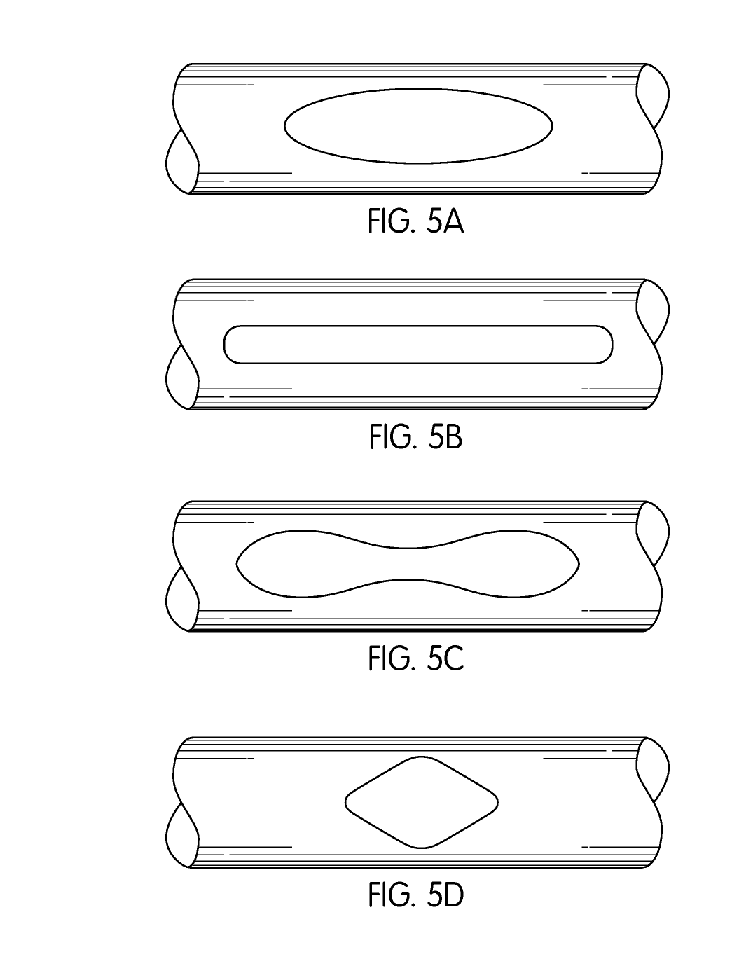

FIGS. 5A-5D illustrate some examples of the variety of possible shapes for the ports. Depending on the performance required of the structure at a particular location, more or less decorative port shapes can be used.

In all orientations, the quantity, size, and spacing of the ports can vary according to the performance desired. In addition, the internal wall assists in resisting the stress of impact while striking the percussion instruments. Because the orientation of the drumstick with respect to a percussion instrument may often be unpredictable and may vary many times during a playing session, the embodiment utilizing four tubes to create “X” shaped internal walls is a preferred embodiment. This embodiment will better resist the multidirectional stress caused by using the drumsticks at various orientations. The orientation of the ports in this embodiment can be any combination of 0 degree alignment or 90 degree alignment.

In other aspects of the invention, the preferred embodiments use multiple continuous composite tubes which are separated to form apertures in the form of double opposing arches at various locations in the drumstick.

This invention allows the shaft of the drumstick to be custom tuned in terms of its stiffness and resiliency by varying the material used, the orientation of the reinforcing fibers, the geometry of the drumstick, and the size, number, orientation and spacing of the ports in the drumstick.

The process of molding with composite materials facilitates the use of multiple tubes in a structure. The most common method of producing a composite drumstick is to start with a raw material in sheet form known as “prepreg” which is reinforcing fibers impregnated with a thermoset resin, such as epoxy. The resin is in a “B Stage” liquid form which can be readily cured with the application of heat and pressure.

The fibers can be of any orientation, but are preferably woven like a fabric or unidirectional, and are high performance reinforcement fibers such as carbon, aramid, glass, etc. The resin may be an epoxy, polyester, vinyl ester, nylon, polyamide resins, ABS or PBT.

The prepreg material commonly comes in a continuous roll or can be drum wound which produces shorter sheet length segments. The prepreg is cut at various angles to achieve the correct fiber orientation, and these strips are typically overlapped and positioned in a “lay-up” which allows them to be rolled up over a mandrel to form a tube. When molding the same drumstick using two prepreg tubes, each tube should be approximately half the size of the single tube, for three, a third of the size, etc.

An inflatable bladder, typically composed of nylon or polymer, is inserted into the middle of each prepreg tube and is used to generate internal pressure to consolidate the plies upon the application of heat. The mold packing process consists of taking each prepreg tube and internal bladder and positioning them in a mold cavity. An air fitting is then attached to the bladder. The process is repeated for each tube. Care must be taken in positioning each tube so that the internal wall formed between the tubes is oriented properly, and that pins can be inserted between the tubes to form the ports during pressurization. The pins which separate the prepreg tubes where ports are desired are then secured into the appropriate portions of the mold. The geometry of the pins must match the desired shape of the ports.

The mold is then pressed closed in a heated platen press and air pressure for each bladder is applied simultaneously to retain the size and position of each tube and the wall formed at the interface of the tubes. Preferably, the bladders will be inflated with an equal air pressure. Simultaneously, the tubes will form around the pins to form the ports. As the temperature rises in the mold, the viscosity of the epoxy resin decreases and the tubes expand, pressing against each other until expansion is complete and the epoxy resin is cross linked and cured. The mold is then opened, the pins and bladders are removed, and the part is removed from the mold.

The orientation of the internal reinforcing wall can be positioned to take advantage of the anisotropy it offers. If more bending flexibility is desired, the wall can be positioned along the neutral axis of bending. If greater stiffness is needed, then the wall can be positioned like an “I Beam” at 90 degrees to the neutral axis to greatly improve the bending stiffness.

Molding the tubular parts using multiple tubes allows greater design options. Separating the hollow tubes at selected axial locations along the shaft to mold openings between the tubes allows the characteristics of the drumstick to be varied as desired.

The molding of the ports at selected locations results in a double opposing arch construction. When the ports are oval in shape, two opposing arches are created, which allow the tubular shaft to deflect, while still retaining the cross sectional shape of the shaft because of the three dimensional wall structure provided by the port. For example, a ported double tube structure has a combination of exterior walls which are continuous and form the majority of the structure, and ported walls, which are oriented at an angle to the exterior walls, which provide strut-like reinforcement to the tubular structure. The cylindrical walls of the ports prevent the cross section of the tube from collapsing, which significantly improves the strength of the structure.

The stiffness and resiliency of the ported multi-tube structure can be adjusted to be greater or less than a standard single hollow tube. This is because of the option of orienting the internal wall between the tubes as well as the size, shape, angle and location of the ports. The ports provide more flexibility in bending stiffness in the plane parallel to the port axes. In other words, if the drumstick is oriented with its longitudinal axis horizontal and the ports are oriented with the axes vertical, the drumstick will be more flexible in the vertical plane. The ports also provide more shock absorption and vibration damping from impacts to the drum because the ports can deflect, which absorbs energy. If a drumstick with greater stiffness is preferred, the drumstick may be rotated to orient the ports so the axes or the ports are horizontal. In addition, using different materials or a lay-up of different fiber angles can effect the desired performance characteristics of the structure, such as stiffness.

The structure can be further refined by using more than two tubes. For example, using three tubes allows for ports 20 to be positioned at 120 degree offsets, providing specific stiffness tailoring along those directions. Using four tubes provides the possibility of having apertures at ninety degree offsets to each other and alternately located along the length of the tubular part to achieve unique performance and aesthetic levels. Another option is to locate the multiple ports in the same location to achieve more of an open truss design.

In another embodiment, a portion having a single composite tube construction is combined with a multiple tube composite portion. In this example, the single composite tube can be a portion of the drumstick and co-molded with the multiple tubes to produce a lighter weight alternative to a 100% multiple tube construction.

In this embodiment, the composite single tube can be a portion of the drumstick and fused or co-molded with the multiple prepreg tubes. This can produce a lighter weight structure that can still achieve the performance and aesthetic requirements of the product.

Preformed portions of the drumstick may also be fused or molded to the portion composed of multiple prepreg tubes. For example, the handle section may be pre-molded and then joined with the portion of the drumstick in which the ports are defined. The pre-molded portion may be composed of a material other than a composite material, such as metal, wood, or plastic.

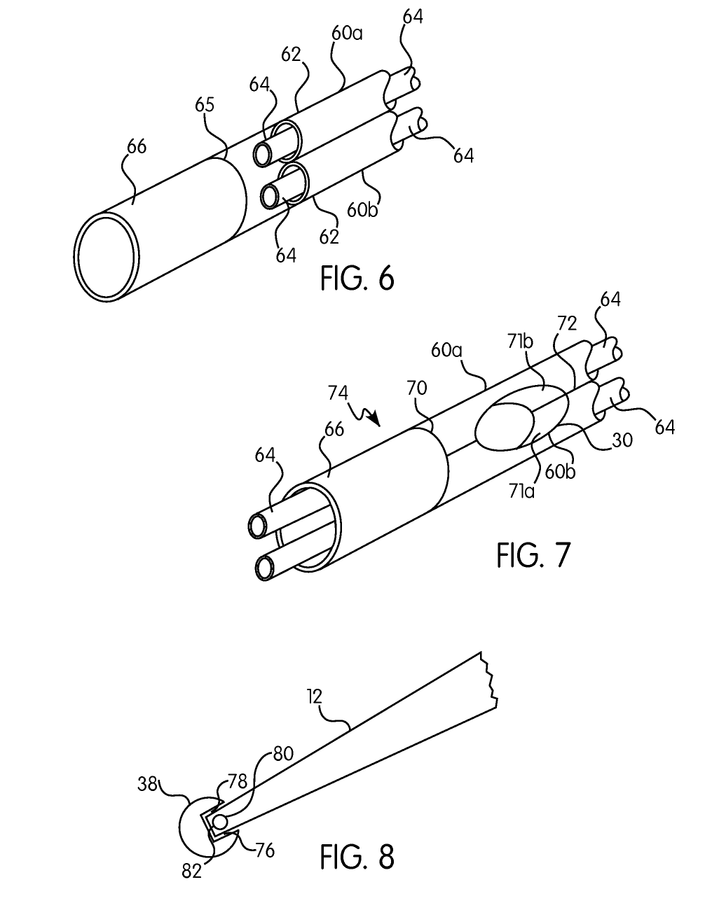

Referring to FIGS. 6-7, to make this construction, forward ends 62 of a pair of prepreg tubes 60a, 60b, each having an inflatable bladder 64, are inserted into one end 65 of a composite single tube 66. The unit is placed inside a mold having the same shape of composite single tube 66, at least at the juncture 70 where prepreg tubes 60a, 60b and composite single tube 66 are to be joined. A pin or mold member (not shown) is placed between prepreg tubes 60a, 60b where port 30 is to be formed. The mold is then closed and heated As bladders 64 are inflated, prepreg tubes 60a and 60b are forced to assume the shape of the mold. The mold member keeps facing walls 71a, 71b apart so as to form port 30. As shown, prepreg tubes 60a and 60b will form a common wall at seam 72.

After the prepreg tubes have cured, frame member 74 is removed from the mold, and the mold member or pin is removed, leaving port 30. In this embodiment, seam 70 between composite portions 60a and 60b of frame member 74 and composite single tube portion 66 should be flush.

Yet another option is to construct a double opposing arch structure using metal materials. The preferred method to produce this structure is to start with a metal tube with a “D” shaped cross section. The tube can then be formed with a half arch bend along a portion of its length. A similar operation can be done with another metal tube. The two tube halves can then be attached by fixing the flat sides of the D shaped cross sections so that the two half arches oppose each other. The tubes can be welded or bonded together resulting in a structure with an internal reinforcing wall and a double opposing arch shaped aperture.

An alternative method to produce a multiple tube structure out of metal is to start with a metal tube such as aluminum, titanium, steel, or magnesium, and to deform the tube in local areas to create dimples or craters in the surface of the tube on opposing sides. The centers of these dimples can be removed leaving a circular aperture through the tube. A tubular section can then be positioned through these circular apertures and fixed to the edges of this dimple area of the primary tube using a welding process to create the 3D structure. The result will be a structure with the primary tube being a single hollow tube with other single hollow tubes attached in a transverse manner internal to the primary tube.

The ported double tube construction can also provide more comfort to the musician. As mentioned previously, the stiffness of the tubular part can be optimized to provide greater flexibility if desired. For example if the ports are oriented at 0 degrees to the direction of striking, a more flexible stick results, providing enhanced musician comfort.

Another advantage of the invention is the absorption of the shock wave traveling up axis of the stick, such as when striking the hard rim of a drum. Having ports along the length of the stick which can deform and absorb this force can also enhance musician comfort.

Yet another advantage of the invention is vibration damping. Vibrations are damped more effectively with the opposing double arch construction. This is because the movement and displacement of the arches absorbs energy, which damps vibrations. As the tubular parts deflect, the shape of the ports can change, allowing a relative movement between the portions of the tube either side of the port. It is this movement which effects the absorption of energy, which damps vibrations.

The ports also provide an aerodynamic advantage by allowing air to pass through the drumstick. This can facilitate the maneuverability of the drumstick when playing at a fast pace. It also allows for a larger drumstick diameter to be as maneuverable as a smaller diameter stick.

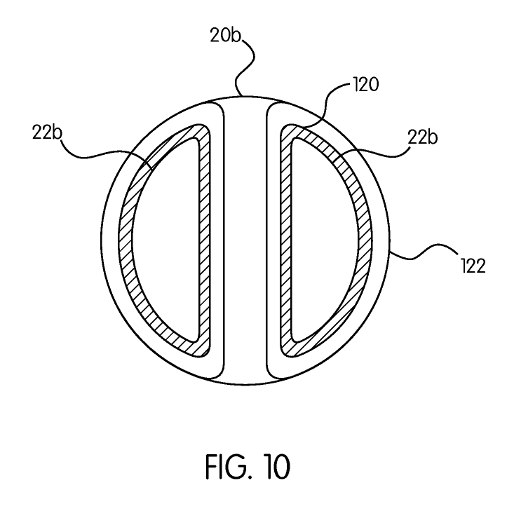

In another embodiment of the invention, an impact protection layer may be added to the exterior surface of the drumstick. The impact of the drumstick on the metal rim of a drum can be severe, and composite materials may be susceptible to impact damage if a rigid resin is used such as epoxy. FIG. 10 is a cross sectional view of a drumstick with an exterior protective impact layer. In this example an internal composite drumstick structure 120 is protected by an impact layer 122. The internal structure 122 is formed as previously described (except with a smaller diameter to accommodate protective layer 122) with composite internal tubes 22b with are separated to form port 20b. After the internal structure 120 is formed, the impact layer 122 is formed over the internal structure 120. The protective impact layer 122 is preferably a tough thermoplastic material such as polyurethane, surlyn, nylon, or similar. It is also possible to add reinforcement fibers to the protective impact layer to further increase its strength. The thickness of the protective impact layer can vary between 0.2 mm to 2.0 mm, preferably between 0.5 mm-1.0 mm. The protective impact layer is preferably formed by injection molding. Another alternative method is to use a film that is placed in the mold between the mold cavity and the prepreg tubes, allowing the impact layer to be co-cured to the internal tubes as internal air pressure is applied. Yet another alternative is to spray the impact layer onto the stick or to dip the stick in a solution of the material of which the impact layer is to be formed.

In yet another embodiment, the ports may be filled with an elastomeric vibration damping material. As the drumstick flexes from impact, the ports will deform and compress the material inside the port, which will further help to absorb vibrations. This material may be a visco-elastic material, rubber, PVC or foam rubber. Alternatively, this material can be the same material used for the protective impact layer. The material can be translucent or transparent to give the drumstick a unique cosmetic appearance. To change the weight and balance of the stick, weights may be disposed within the ports. The weights may be configured to snap in and out of the ports such that the drummer can custom configure the drumstick in this manner.

Finally, there is a very distinguished appearance to a drumstick made according to the invention. The ports are very visible, and give the tubular part a very lightweight look, which is important in drumstick marketing. The ports can also be painted a different color, to further enhance the signature look of the technology.

There are unlimited combinations of options when considering a double opposing arch structure. The ports can vary by shape, size, location, orientation and quantity. The ports can be used to enhance stiffness, resilience, strength, comfort, aerodynamics and aesthetics. For example in a low stress region, the size of the port can be very large to maximize its effect and appearance. If more deflection or resilience is desired, the shape of the aperture can be very long and narrow to allow more flexibility. The ports may also use customized or designer shapes to give the product a stronger appeal.

If more vibration damping is desired, the ports can be oriented and shaped at a particular angle, and constructed using fibers such as aramid or liquid crystal polymer. As the port deforms as a result of shaft deflection, its return to shape can be controlled with visco-elastic materials which will increase vibration damping.

In another aspect of the invention, a tip may be attached subsequent to the formation of the drumstick. Having a port at the tip area of the tapered portion that is inserted into a tip provides a mechanical means of attachment to the tip to better secure the shaft to the tip. FIG. 8 shows such an example with the tapered portion 12 of the drumstick 10 inserted into the cavity 76 of the tip 38. The tip 78 of shaft 10 has a port 80 into which a pin 82 is inserted. The pin 82 is also attached to the tip 38 to provide a secure attachment means. Port 80 is formed as previously described, and is preferably circular in shape to accommodate attachment pin 82.

FIG. 9 illustrates a process which may be used to make the drumstick of FIG. 1. A pair of prepreg tubes 100, 102 extend side-by-side from butt end 14 towards tip end 16. At tip end 16, the inside, common wall 104 of tubes 100, 102 is cut out, the outside walls of prepreg tubes 100, 102 are then folded over one another, so as to close off the forward end and create space 106 between outside walls 108 and forward end 105 of common wall 104.

An inflatable bladder 110 extends through the interior of one prepreg tubes 100, through space 106 at forward tip 16, and back through the other prepreg tube 102, so that opposite ends 112, 112a of the bladder 110 extend out of open butt end 14 of the tubular lay-up. A mold pin 114 is inserted between facing walls 104 of the tubes 110, 112 to form a port. This structure is then placed in a mold which is heated, while bladder 110 is inflated, to form the drumstick. After molding a cap, e.g., 15, may be secured by any suitable means to close off the butt end 14 of the drumstick.

Alternately, the drumstick can be molded with the butt end 114 closed and the tip end 16 open (i.e., the opposite of FIG. 9), in which case the drumstick tip is secured after molding. The drumstick shaft can also be molded with both ends open, using a pair of inflatable bladders. In either such case, the tip and/or butt may, if desired, be closed off after molding by securing a tip and/or butt piece, respectively, to the drumstick shaft. In such a case, the ends of the tubes would not be folded over one another.

With respect to the above description, it is to be realized that the optimum dimensional relationships for the parts of the invention, including variations in size, materials, shape, form, function and manner of operation, assembly and use, are deemed to be with the scope of the invention, and all equivalents to those embodiments illustrated in the drawings and described in the specification are intended to be within the scope of the present invention.

The foregoing descriptions and detailed descriptions of the invention are considered to be only exemplary and illustrative in nature and are not intended to limit the invention in any manner as to the exact construction and operation shown and described, and accordingly, all suitable modifications and equivalents may be resorted to, falling within the scope of the invention.

We claim:

1. A drumstick comprising:
a. two or more hollow tubes having facing surfaces, wherein said facing surfaces are fused together along portions of their lengths to form an internal reinforcing wall;
b. wherein the surfaces of said two or more tubes not facing the surface of another of said tubes forms a portion of the external surface of said drumstick.

2. The drumstick of claim 1 wherein one or more ports extend through said drumstick.

3. The drumstick of claim 2 wherein the axes of said ports are orthogonal to the longitudinal axis of said drumstick.

4. The drumstick of claim 1 wherein said tubes are composed of a composite material.

5. The drumstick of claim 4 wherein said composite material is a fiber reinforced resin.

6. The drumstick of claim 5 wherein said fibers are selected from a group consisting of carbon, fiberglass, aramid and boron.

7. The drumstick of claim 3 wherein said resin is selected from a group consisting of epoxy, polyester, vinyl ester, nylon, polyamide resins, ABS and PBT.

8. The drumstick of claim 2 wherein said one or more ports are formed by separating said facing surfaces of said two or more tubes in one or more locations.

9. The drumstick of claim 2 comprising three hollow tubes, wherein said internal reinforcing wall is Y-shaped.

10. The drumstick of claim 9 wherein one or more Y-shaped ports having openings located 120 degrees apart extend through said drumstick

11. The drumstick of claim 1 comprising four hollow tubes, wherein said internal reinforcing wall is X-shaped.

12. The drumstick of claim 11 defining a plurality of ports therein, wherein one or more ports have axes oriented in a first direction and one or more ports have axes oriented in a second direction orthogonal to said first direction.

13. The drumstick of claim 12 wherein one of said ports having an axis oriented in a first direction and one of said ports having an axis oriented in a second direction are co-located along said drumstick, forming a port having four openings.

14. The drumstick of claim 12 wherein one or more of said ports having an axis oriented in a first direction and one or more of said ports having an axis oriented in a second direction are disposed at different locations along said drumstick.

15. The drumstick of claim 2 wherein said one or more ports vary in size.

16. The drumstick of claim 2 wherein said one or more ports vary in shape.

17. The drumstick of claim 16 wherein said ports are circular, elliptical or oval in shape.

18. The drumstick of claim 2 wherein said one or more ports vary in size and shape.

19. The drumstick of claim 2 wherein said one or more open ports are spaced evenly along said drumstick.

20. The drumstick of claim 2 wherein said one or more ports are unevenly spaced along said drumstick.

21. The drumstick of claim 1 having a cross sectional shape other than circular along at least a portion of its length.

22. The drumstick of claim 1 further comprising a protective coating disposed on the external surface thereof.

23. The drumstick of claim 22 wherein said protective coating is comprises a film of composite cured to the external surface of said drumstick.

24. The drumstick of claim 22 wherein said protective coating is injection-molded to the exterior surface of said drumstick.

25. The drumstick of claim 1 wherein said protective coating is applied by spraying or dipping.

26. The drumstick of claim 1 wherein a portion of said drumstick is tapered.

27. The drumstick of claim 1 having a round port defined near one end thereof to facilitate the attachment of a tip.

28. The drumstick of claim 27 further comprising a tip, attached to said drumstick, and a pin, disposed in said round port, to hold said tip in place.

29. The drumstick of claim 1 further comprising a portion constructed from a single tube, said single tube portion being fused to said two or more hollow tubes.

30. The drumstick of claim 29 wherein said single tube portion is composed of a composite material and is co-cured with said two or more hollow tubes.

31. The drumstick of claim 1 further comprising a pre-formed portion fused to said two or more hollow tubes.

32. The drumstick of claim 31 wherein said pre-formed portion is composed of a material other than a composite material.

33. The drumstick of claim 2 wherein said one or more ports are filled with a visco-elastic material.

34. The drumstick of claim 2 further comprising weights disposed with one or more of said ports.

35. The drumstick of claim 34 wherein said weights are configured to snap in and out of said ports.

36. A method of forming a drumstick comprising the steps of:
a. forming two or more hollow tubes of an uncured composite material;
b. inserting an inflatable bladder into each of said hollow tubes;
c. placing said hollow tubes into a mold;
d. inserting mold elements disposed between facing surfaces of said a hollow tubes at one or more locations to separate said facing surfaces; and
e. heating said mold, while inflating said bladders, such that said facing surfaces of said hollow tubes fuse together except in the locations where said mold pins are located, and the non-facing surfaces of said hollow tubes assume the shape of the mold and cures.

37. The method of claim 36 wherein each of said inflatable bladders is inflated to the same pressure.

38. The method of claim 36, further comprising the step of joining one or both ends of said drumstick to one or more pre-formed portions.

39. The method of claim 38 further comprising the step of applying an overlap joint of a composite material between said drumstick and said one or more pre-formed portions.
